(19) United States
(12) Patent Application Publication
(10) Pub. No.: US 2005/0046242 A1
(43) Pub. Date: Mar. 3, 2005

(54) Motor vehicle roof with a roof opening and a movable roof cover

(75) Inventors: Francois De Gaillard, Paris (FR); Manfred Farber, Wielenbach (DE)

Correspondence Address: NIXON PEABODY, LLP, 401 9TH STREET, NW, SUITE 900, WASHINGTON, DC, 20004-2128, US

(73) Assignee: Webasto AG, Stockdorf (DE)

(21) Appl. No.: 10/885,963

(22) Filed: Jul. 8, 2004

(30) Foreign Application Priority Data
Jul. 9, 2003 (DE) 103 31 143.2

(51) Int. Cl. B60J 7/043

(52) U.S. Cl. 296/216.08

(57) ABSTRACT

A motor vehicle roof with a roof opening and a movable roof cover for closing, or at least partially clearing, the roof opening located between two side members of the motor vehicle roof. The two side members on the motor vehicle roof are movably supported in the transverse direction. With the roof opening cleared, the two side members are adapted to be moved between an outside position, and an inside position.

### BACKGROUND OF THE INVENTION

1. Field of the Invention

The invention relates to a motor vehicle roof with a roof opening and a movable roof cover for closing or at least partially clearing the roof opening located between two side members of the motor vehicle roof.

2. Description of Related Art

German Patent DE 197 13 347 C1 and its counterpart U.S. Pat. No. 6,158,803 disclose a motor vehicle roof in which a cover is supported on the motor vehicle roof such that it can be moved rearwardly out of its closed position in the roof opening over the fixed motor vehicle roof. However, the roof opening which is cleared when the cover is opened is bordered in the conventional manner by the side members of the roof. Thus, in contrast to the open roof of a convertible, an impression similar to an opened convertible for the driver or passenger will not arise even with the roof opening cleared.

### SUMMARY OF THE INVENTION

The primary object of the present invention is to provide a motor vehicle roof in which the roof structure is changed when the roof opening is cleared.

This primary object is achieved by a motor vehicle roof of the present invention in which two side members on the motor vehicle roof are movably supported in the transverse direction, and are movable between their outside position and the inside position in which the two side members are approached together and positioned adjacent to each other when the roof opening is cleared. By moving the side members away from their outside position, the driver or passenger acquires the impression of a roof which has been opened like a convertible. This advantage is emphasized especially with the side windows lowered, when there is a large unobstructed opening provided by the positioning of the side members along the centerline of the motor vehicle. Since the movably supported side members need not be manually removed from the motor vehicle roof, they do not require a separate stowage space on or in the vehicle. The side members may be implemented so that they can be manually shifted or pushed, or also moved by a driving mechanism.

Advantageously, each side member preferably includes a guide for the movable roof cover. The guide can be used to support the roof cover, or to support a cover on the front edge and, optionally, also on the rear edge of the roof cover. The cover may be part of an externally guided sliding roof, for example.

If each side member is movably supported in the area of its front end on a front transverse roof component, and in the area of its back end on a rear transverse roof component, reliable guidance of the side members is provided. Depending on the configuration of the roof, it can then be possible for the front path of movement and the rear path of movement of each side member to have different lengths along the front transverse roof component and the rear transverse roof component when the side members are moved between the outside position and the inside position. Of course, there can also be paths of movement of the same length in various applications of the present invention.

Advantageously, each side member is preferably movably supported by a front and a rear bearing and guide unit on a front and a rear guide of the respective front and rear transverse roof component. The support also keeps the side member guided in the vertical direction, for example, by reaching around or under on the guides.

If each side member is supported on the two bearing and guide units to be able to pivot around the lengthwise axis, each side member can first be raised, for example, out of its initial position on the side roof edge, and can be pivoted up with its outer side so that it is raised from a seal seat. Depending on the construction circumstances, it can also be necessary to move the side member into the position in which it has been pivoted up along the front and the rear transverse roof components.

Preferably, each side member includes a front and a rear drive unit which are in drive contact with the guides of the front and rear transverse roof components. The drive units move the side member both on its front edge and also on its rear edge so that the side member is less likely to become jammed or blocked.

If it is necessary as a result of the different lengths of the displacement paths on the front edge of the side member and on the rear edge of the side member, the front drive unit may be made to traverse a longer or shorter drive path relative to the rear drive unit with simultaneous driving.

According to one simple configuration, the front drive unit and the rear drive unit are mechanically coupled to one another. However, in other embodiments, independent drive sources may be provided, for example, independent drive motors which are electronically controlled. In still other implementations, there can likewise be hydraulic or pneumatic drives.

In one embodiment, the front drive unit and the rear drive unit each have a rotary drive element which is engaged to the guides or to the engagement paths of the guides by form-fit or friction. For form-fit engagement, the engagement path is profiled or toothed for example, and the rotary drive element on its periphery is shaped accordingly. Here, mechanical coupling can be especially easily implemented. In particular, the front drive unit and the rear drive unit each have a drive wheel, the two drive wheels having different action diameters, being rotationally coupled to one another, and traversing different path segments. Advantageously, the front drive unit and the rear drive unit and the drive wheels are connected to one another by a shaft such as a universally jointed shaft or a flexible rotary drive shaft.

When the drive wheels are gears, the teeth of the front drive unit and the rear drive unit can be implemented differently to account for different lengths of the path of movement.

Advantageously, there is a pivoting mechanism for each side member which can move the side member in its pivoting position around the lengthwise axis, the movement depending on the respective position of the side member. Therefore, the pivoting mechanism can have a control path with several path segments on which a control part of the side member is engaged. Preferably, one control arm of the side member is engaged on the control path and assumes the pivoting positions which correspond to the respective path segments of the control path. Thus, the pivoting position of the side member can be fixed over the shape or the course of the path segments.

A control coulisse can be located along the front or the rear guide rail.

Advantageously, a first external path segment is provided which is tilted downward relative to the inwardly pointed displacement direction of the side member, thus controlling the initial inward pivoting of the side member as soon as it is moved out of its outside position.

Furthermore, at least one control coulisse is provided on the displacement path of the side member which accommodates the holding part of the side member. Thus, additional support is achieved, especially in the vertical direction. Advantageously, the holding part is a supporting pin which is located on the control arm of the side member and which is located coaxially to the pivoting axis of the side member. Then, when the side member is pivoted, the supporting pin is guided in a linear control coulisse. Otherwise, the control coulisse would have to be matched to the pivoting position or pivoting movement of the side member. For reliable support, it can be sufficient if there is one outer control coulisse assigned to the outside position of the side member, and there is one inner control coulisse assigned to the inside position of the side member. However, the control coulisse may also be formed to be continuous.

Preferably, a cover, especially a glass cover, forms the front cover. The cover can be moved to the rear over the motor vehicle roof in the open position in which at least its rear edge is raised.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 shows a perspective top view of a passenger car with a motor vehicle roof and a cover in one embodiment of the present invention, the cover having been moved to the rear into an open position to clear the roof opening.

FIG. 2 shows a perspective top view of a roof frame arrangement with two movable side members which are movably supported on two transverse roof components in the transverse direction of the roof.

FIG. 3 shows a side view of the roof frame arrangement with the left movable side member.

FIG. 4 shows an enlarged perspective top view of the front end of the left movable side member with its bearing mechanism on the apron.

FIG. 5 shows an enlarged perspective top view of the back end of the left movable side member with its bearing mechanism on the rear transverse roof component.

FIG. 6 shows a perspective top view of the roof frame arrangement of FIG. 2 with the left movable side member pivoted around its lengthwise axis in its outside position.

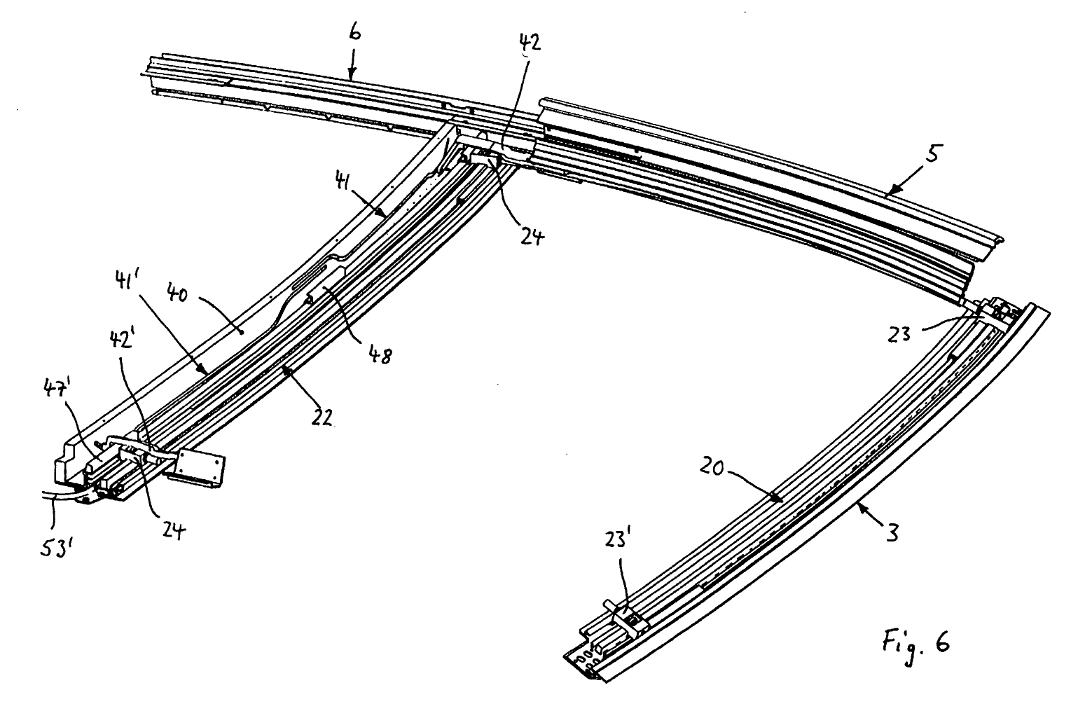

FIG. 7 shows an enlarged perspective top view of the back end of the left movable side member with its bearing mechanism on the rear transverse roof component in the first inwardly moved, intermediate position.

FIG. 8 shows a perspective top view of the roof frame arrangement in FIG. 2 with the two movable side members in another inwardly moved, intermediate position.

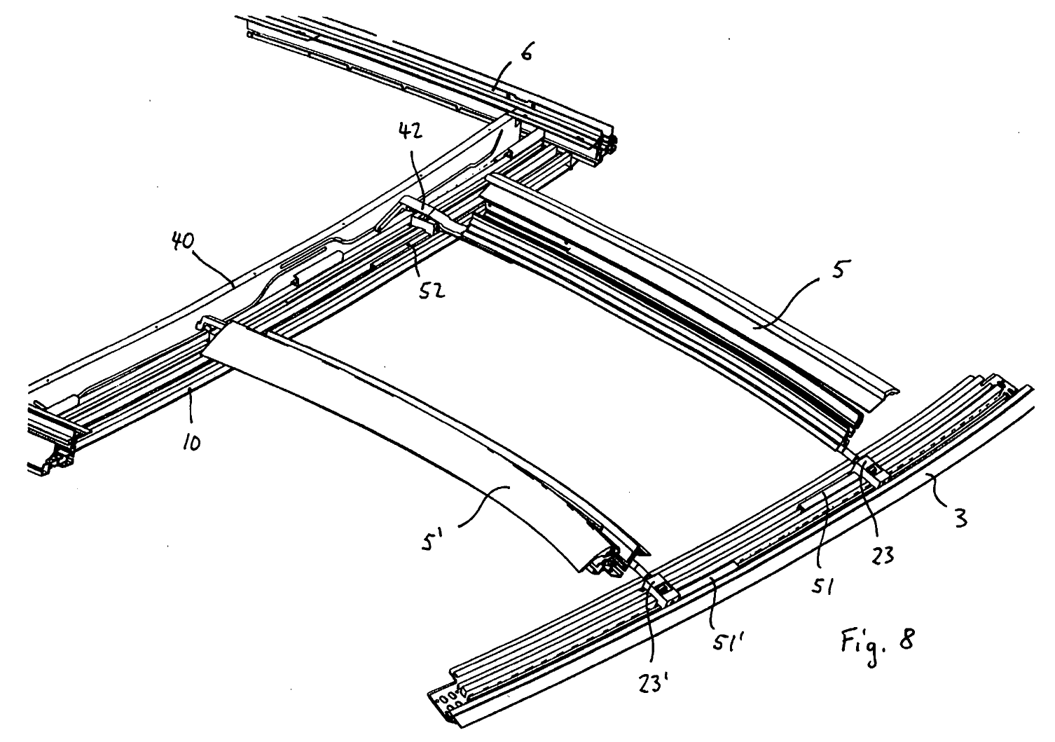

FIG. 9 shows an enlarged perspective top view of the back end of the left movable side member with its bearing mechanism in the intermediate position as shown in FIG. 8.

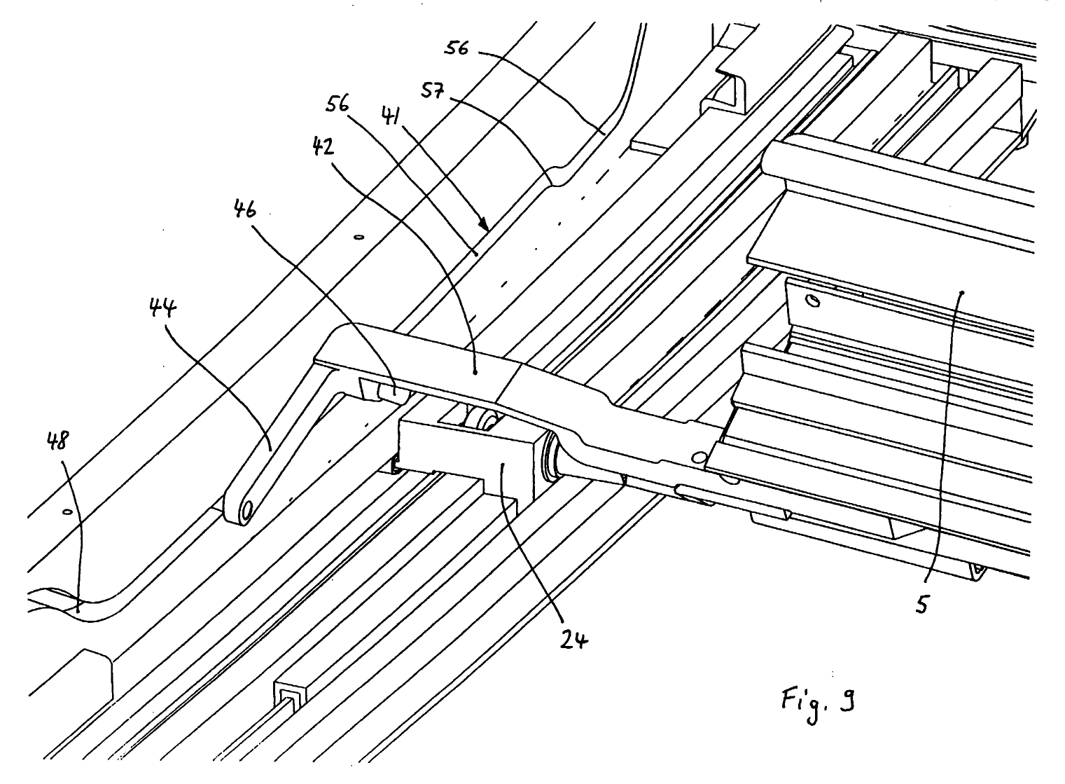

FIG. 10 shows a perspective top view of the roof frame arrangement in FIG. 2 with the two movable side members in their inside or end positions.

### DETAILED DESCRIPTION OF THE INVENTION

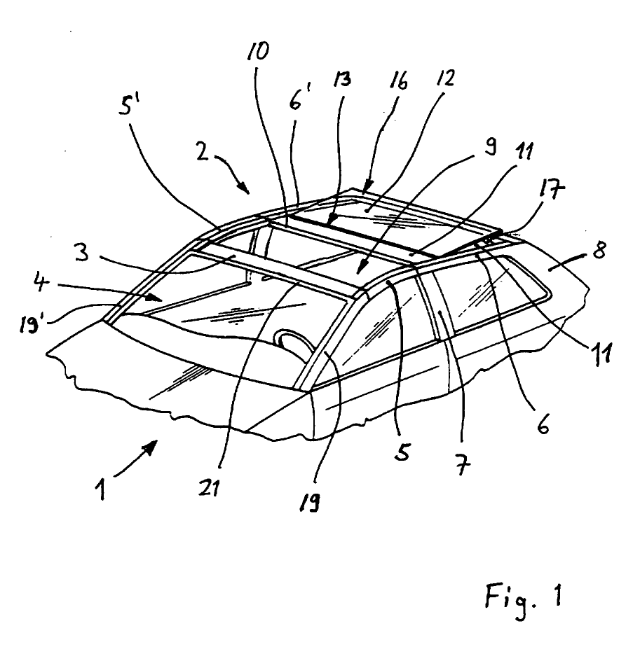

FIG. 1 shows a motor vehicle 1 having a motor vehicle roof 2 with a roof frame arrangement which includes a front transverse roof member or apron 3 above the front window 4, front movable side members 5 and 5′ on each side in accordance with the present invention, and roof-mounted rear side members 6 and 6′ which extend roughly from the B pillar 7 to the C pillar 8. The roof opening 9 extends between the apron 3 and the two movable side members 5 and 5′, and is bordered on the back by the rear transverse roof member 10 which is permanently connected to the rear side members 6 and 6′, or the B pillars 7. The rear fixed roof segment 11 extends between the rear side members 6 and 6′, and between the rear transverse roof member 10 and another transverse roof member at the end of the motor vehicle roof 2, above the back window.

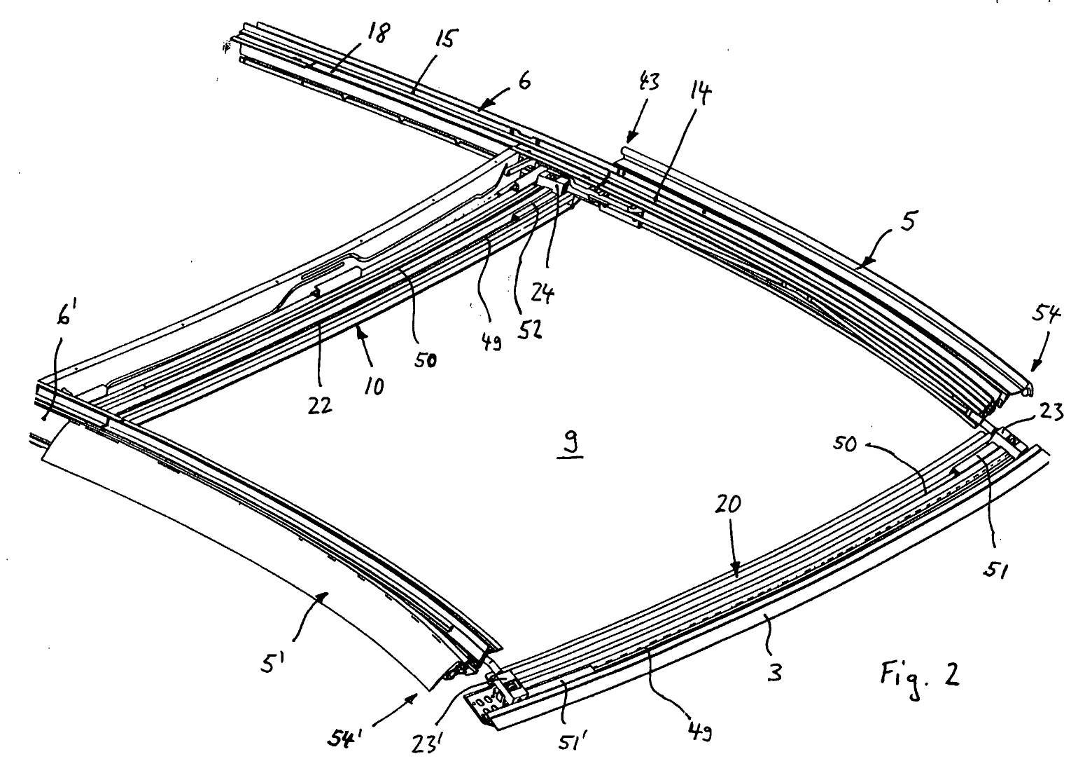

A cover 12 of an externally guided sliding roof, for example a glass cover, is designed for closing, and at least partially clearing, the roof opening 9. The cover 12 in the area of its front edge 13, is movably guided on both sides by a bearing unit on the respective guide mechanisms which, as shown in FIG. 2, includes guide rails 14 on the front side members 5, 5′ and guide rails 15 on the rear side members 6, 6′. In the area of its rear edge 16, the cover 12 is movably supported laterally by a bearing unit 17 on one guide mechanism which includes a guide rail 18 on the rear side members 6, 6′. To clear the roof opening 9, the cover 12 is raised on its rear edge 16 by the bearing units 17, and is moved to the rear over the rear fixed roof segment 11 into the position shown in FIG. 1. This type of cover having a bearing unit and driving mechanism is generally disclosed in the U.S. Pat. No. 6,158,803, which is hereby incorporated by reference, and therefore, the details thereof have not been included herein.

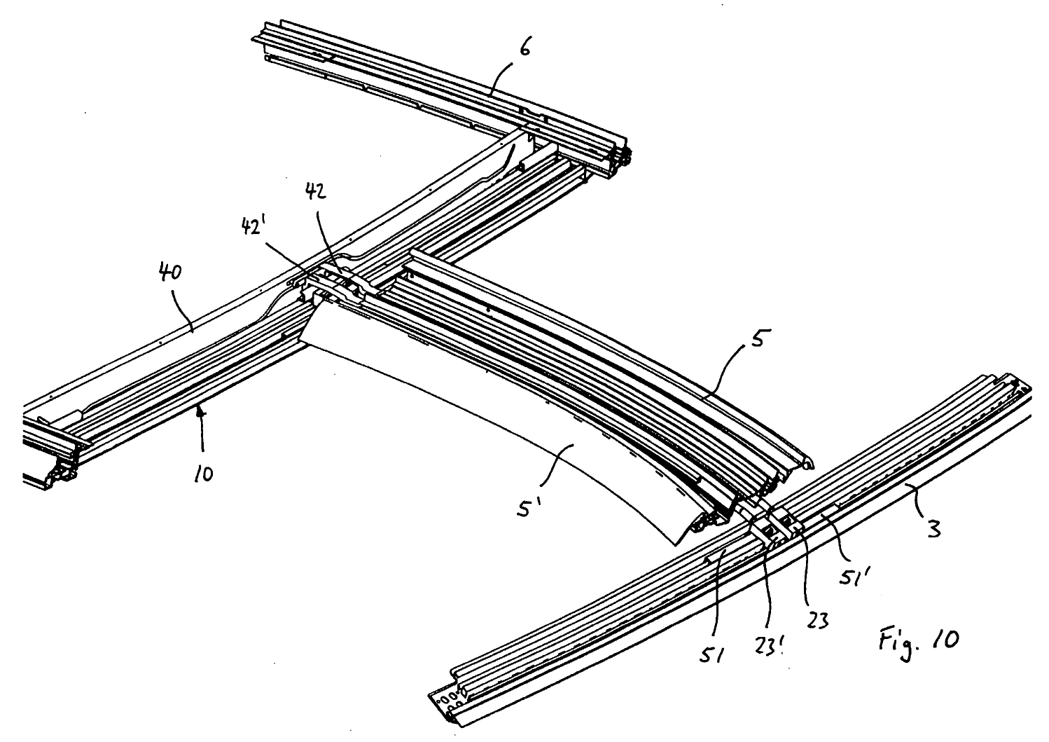

As shown in FIGS. 1 and 2, each of the front side members 5, 5′ are adapted to be moved out of its operating or outside position in which they connect the A pillar 19, 19′ and the apron 3 to the fixed rear side members 6, 6′, and provides the guide rails 14 for supporting or moving the cover 12, into an inside position as shown in FIG. 10 when the cover 12 is located in the rear open position and is not engaged with the guide rail 14. The roof structure is essentially symmetrical with respect to the vertical lengthwise center plane of the motor vehicle so that the two movable side members 5 and 5′ and the bearing and driving mechanisms are described hereinbelow using the left side member 5, the right side member 5′ being implemented in substantially similar manner.

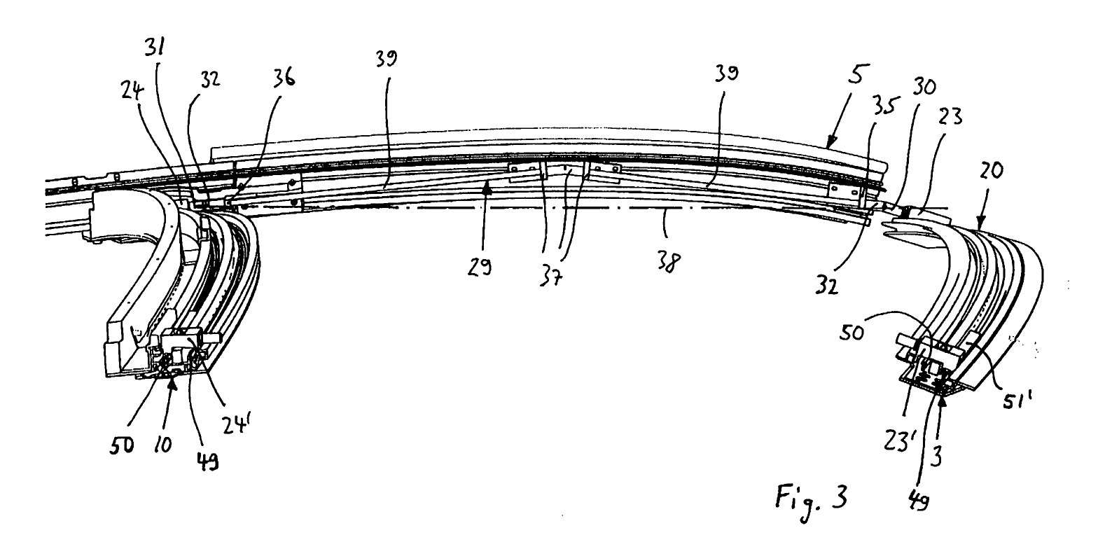

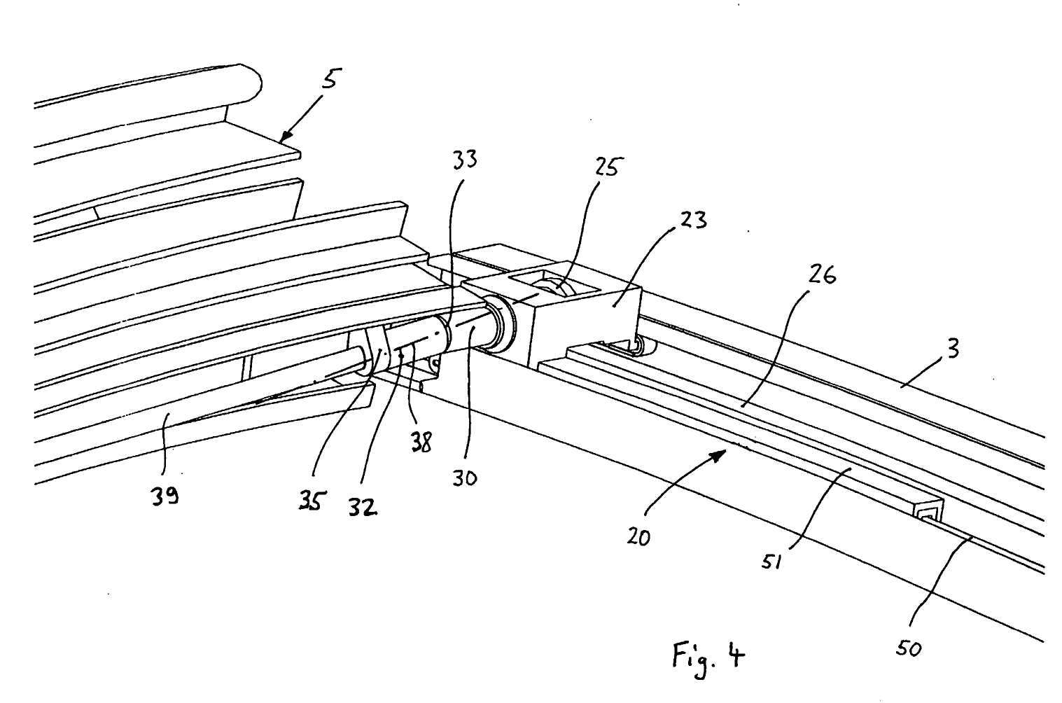

As most clearly shown in FIGS. 2 to 4, the apron 3 has a guide rail 20 which, in the present embodiment, extends between the two A pillars 19, 19′ over the length of the apron 3. According to the frequently conventional shape of a passenger car and its vehicle roof, the top edge 21 of the front window 4 runs along a three-dimensional curve with a middle segment being arched forward and toward the top. In this regard, FIG. 1 is a simplified schematic illustration showing the top edge simplified as a straight line. Accordingly, the apron 3, like the guide rail 20 attached to it, is a three-dimensionally arched or curved component as most clearly shown in FIGS. 2 and 3.

The rear transverse roof member 10 which is a three-dimensionally arched component like the apron 3, also has a guide rail 22 which is matched to the contour of the rear transverse roof member 10.

The front control carriages 23 and 23′ and the rear control carriages 24 and 24′ are movably supported on the front guide rail 20 and the rear guide rail 22 to movably support each of the two movable front side members 5, 5′. On the front control carriages 23, 23′, gears 25, 25′ are pivotally supported and is engaged on teeth 26 provided on the front guide rail 20, for example, the teeth 26 being integrally formed on the front guide rail 20, or separately formed on a rack attached to the front guide rail 20. In the same manner, on the rear control carriages 24 and 24′, gears 27 and 27′ are pivotally supported and engage on the teeth 28 provided on the rear guide rail 22.

Universal joints 29 connect a front control carriage 23, 23′ and a corresponding rear control carriage 24, 24′ of the respective side members 5 and 5′ together, and couples their gears 25 and 27, and gears 25′ and 27′ to one another. The universal joints 29 have a front end piece 30 which is attached to the front control carriage 23 coaxially to the axis of rotation of the gear 25, a rear end piece 31 which is attached to the rear control carriage 24 coaxially to the axis of rotation of the gear 27, and a middle piece 32. The middle piece 32 is hinged at a front articulation point 33 to the front end piece 30, and hinged at a rear articulation point 34 to the rear end piece 31. The side member 5 is supported on the middle piece 32 of the universal joint 29 by a front support 35, a rear support 36 and a middle support 37, so that the side member can be pivoted relative to the motor vehicle roof and the front and the rear control carriages 23 and 24 around the pivoting axis 38 that extends through the front and the rear articulation point 33 and 34 of the universal joint 29. The universally jointed shaft 39 of the universal joint 29 that couples the two gears 25 and 27 to one another, is made in several parts, and is pivotally supported in the front end piece 30 and in the rear end piece 31. The front end piece 30 of the universal joint 29 and the universally jointed shaft is provided with a mechanism for equalizing its length (not shown) so that the effective length of the universal joint 29 can be changed and can be adapted to varying distances between the front guide rail 20 and the rear guide rail 22. Instead of the illustrated middle support 37 with only one articulation point of the universal joint 29, there may also be provided several middle supports for connecting the universal joint 29 to the side member 5 in other embodiments. Accordingly, repeated subdivision and deviation of the universally jointed shaft 39 may be implemented so that the universally jointed shaft 39 can be adapted to the shape of the side member 5, especially in applications where the side members of the vehicle have more pronounced curvature.

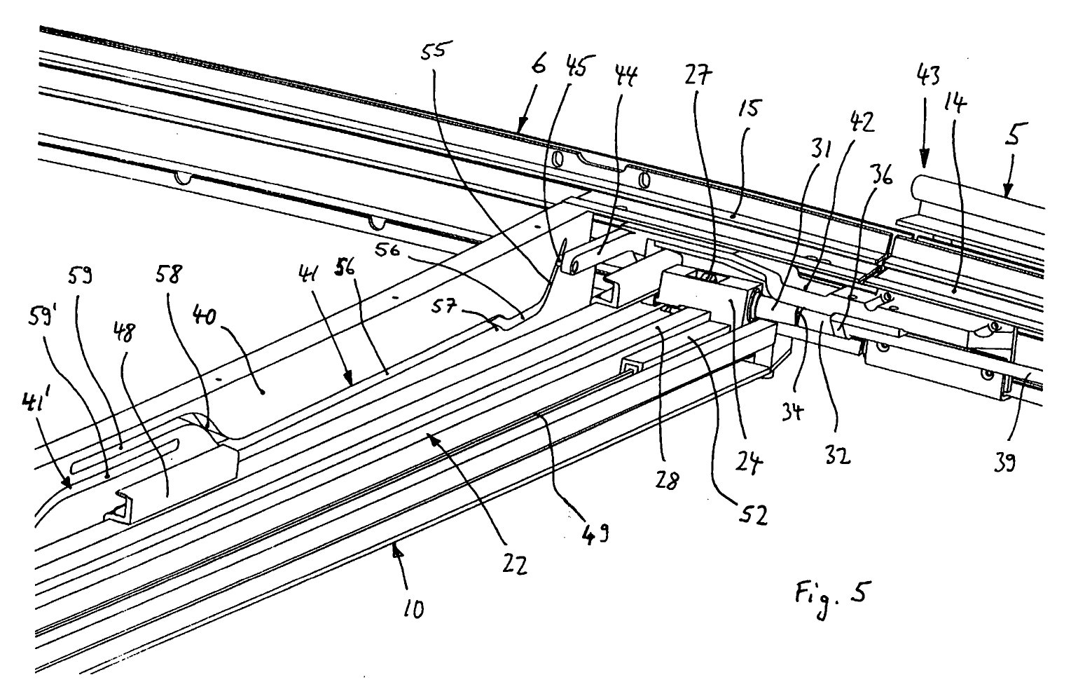

The rear transverse roof member 10 includes a control coulisse 40 as most clearly shown in FIG. 5, the control coulisse 40 extending between the two fixed side members 6 and 6′ and providing a control path 41 and 41′ for each movable side members 5 and 5′. A holding part 42 which projects to the rear beyond the back end 43 of the side member 5 includes an inwardly extending control arm 44 with a control pin 45 on its end. The control pin 45 is movably held in the control path 41 of the control coulisse 40, so that the side member 5 is guided along the control path 41. The respective position of the control pin 45 relative to the rear control carriage 24 and the pivoting axis 38 of the side member 5 fixes the pivot position of the side member 5 around the pivoting axis 38.

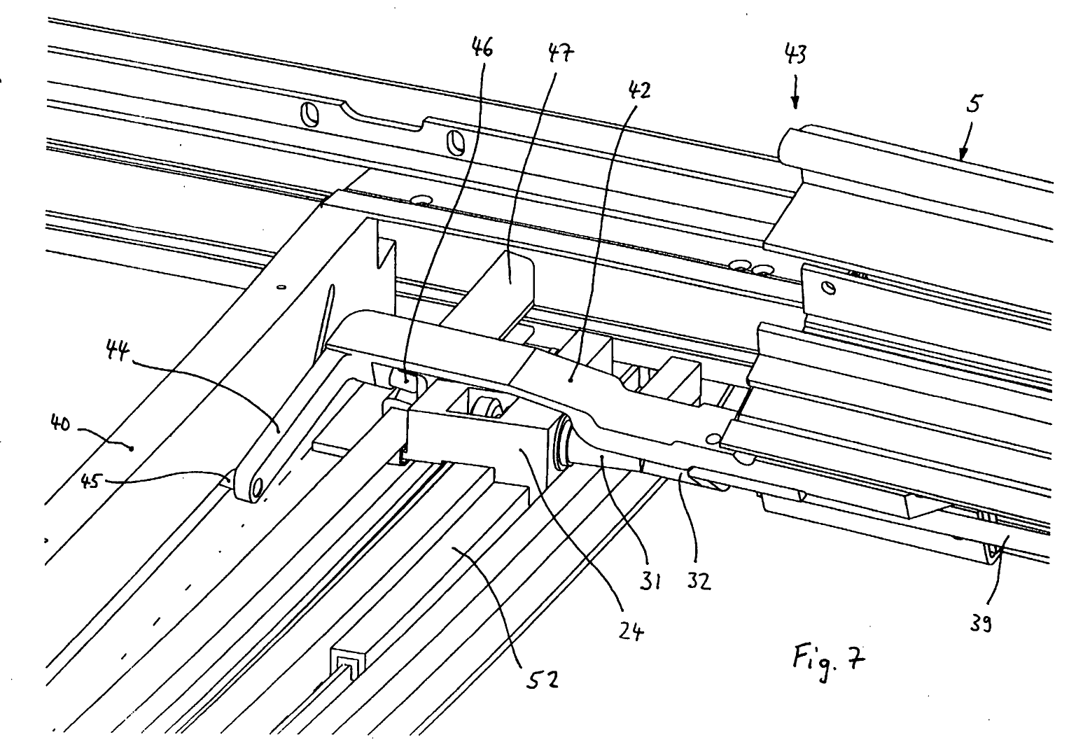

As shown in FIG. 7, a supporting pin 46 is provided on the holding part 42, or alternatively, on the control arm 44. The supporting pin 46 is coaxial to the pivoting axis 38 of the side member 5 and thus, is not moved out of the pivoting axis 38 when the side member 5 is pivoted. The rear transverse roof member 10 includes a U-shaped coulisse 47 of limited length at each of its two outer ends, the U-shaped coulisse 47 being open to the rear and in which the supporting pin 46 is held without play in and near the outside position of the side member 5. A corresponding middle coulisse 48, as also shown in FIG. 5, is attached in the middle of the rear transverse roof member 10, and guides the supporting pins 46 of the two side members 5 and 5′ in their inner position.

The front guide rail 20 as well as the rear guide rail 22 each have two guide crosspieces 49 and 50 which are pointed upwardly in the present embodiment, and which are located on either side of the teeth 26 and 28, i.e. positioned in front of or behind the teeth 26 and 28 with respect to the lengthwise axis of the motor vehicle. The two front control carriages 23 and 23′ each have a guide extension 51 and 51′ respectively, which is pointed toward the middle of the vehicle and is made as a U-shaped section to adjoins and interface with the respective guide crosspiece 49 and 50 or extends around the guide crosspiece from overhead. For example, the guide extension 51 on the left front control carriage 23 is arranged such that it is supported on the rear guide crosspiece 50, while the guide extension 51′ on the right front control carriage 23′ is arranged such that it is supported on the front guide crosspiece 49. In the inner position of the two side members 5 and 5′ in which they adjoin one another in the middle of the roof, the two guide extension 51 and 51′ can therefore be positioned parallel next to one another as shown in FIG. 10. The two rear control carriages 24 and 24′ have guide extensions 52 and 52′ that are implemented in a similar manner.

The two rear control carriages 24 and 24′ are each connected to a compressively stiff drive cable 53 and 53′ which is guided on the rear guide rail 22, such drive cables being known in the sliding roof drive art. The two drive cables 53 and 53′ are driven synchronously by a common drive motor. When the rear control carriage 24 is pushed along the rear guide rail 22 by the drive cable 53, the universally jointed shaft 39 of the universal joint 29 transfers the rotation of the rear gear 27 to the front gear 25 so that it moves the front control carriage 23 simultaneously with the rear control carriage 24.

Due to the shape of the motor vehicle roof, the two outside ends of the apron 3 lie farther to the outside relative to the two ends of the rear transverse roof member 10. Accordingly, each of the movable side members 5, 5′, when in their outside position, has a front end 54 which is arranged farther to the outside with respect to the vertical lengthwise center plane of the motor vehicle than the back end 54. When the side members 5, 5′ are moved out of their outside position into their inside position in which the two side members 5, 5′ are arranged roughly parallel to the vertical lengthwise center plane of the motor vehicle and adjoin one another, the front end 54 of the side member 5 must traverse a longer path along the front guide rail 20 as compared to its back end 43. Since the universally jointed shaft 39 has the same rotation on its front end and its back end when the side members 5, 5′ are moved, the respective units including the gear 25 and rack 26, and the gear 27 and rack 28 on the front and the rear control carriages 23 and 24 respectively, must be made differently so that the front control carriage 23 can traverse a correspondingly longer path segment compared to the rear control carriage 24. In this embodiment the two gear tooth pairings are formed with different modulus so that with the same speed of rotation the front gear 25 traverses a longer path segment compared to the rear gear 27. For example, the rear gear 27 may be implemented with fifteen teeth and a pitch circle diameter of 15 mm at a modulus of 1.0, conversely the front gear 25 with likewise fifteen teeth has a pitch circle diameter of 15.47 mm at a modulus of 1.03.

In order to completely clear the roof opening 3, the cover 12 is moved out of its closed position by a driving mechanism along the guides 14 and 15 on the side members 5, 5′ and 6 and 6′, and to the rear. In doing so, the cover 12 is moved over the rear roof section 11 into its open position in which its bearing mechanism is disengaged from the guides 14 of the front side members 5, 5′. Then the driving mechanism for the two side members 5, 5′ is activated so that the two drive cables 53, 53′ push the two rear control carriages 24 and 24′ inward. On the left side member 5, the control pin 45 is initially moved down in the outer segment 55 of the control path 41 which runs steeply downwardly as shown in FIG. 5, so that the control arm 44 and the holding part 42, and thus the side member 5, are pivoted by the pivoting mechanism described.

In this manner, as the side member 23 is moved inwardly along the first displacement path of the rear control carriage 24 by the motion transferred by the universally jointed shaft 39 that is simultaneously to the front control carriage 23, the side member 23 is pivoted around its pivoting axis 38, its outer side being raised out of contact with the seal arrangement on the apron 3 and on the rear side member 6.

The control path 41 following the first outside path segment 55 which is tilted steeply down, has a second path segment 56 which runs essentially parallel to the rear guide rail 22. When the control pin 45 moves along this second path segment 56, the side member 5 essentially retains its pivoted position as it is moved inward. A small shoulder 57 on the second path segment 56 and a path segment 56 which is subsequently higher, can cause a minor pivoting-back of the side member 5. Towards the middle of the roof, the control path 41 contains a rising third path segment 58 which passes into a fourth path segment 59 in the middle of the roof, which runs parallel to the guide rail 22 in the latter segment. The control pin 45 which is guided up in the rising third path segment 58 pivots the side member 5 back again into, or almost into, the position it assumes in its outside position. This position is assumed in the inner position toward the middle of the roof, in which latter position the control pin 45 is guided in the fourth path section 59. On the last displacement path of the side member 5 and the control carriages 23 and 24, the supporting pin 46 enters the middle coulisse 48 and additionally offers reliable support of the rear control carriage 24, and thus, of the side member 5 in its inside position.

The right side member 5′ can be moved in its pivoting position in a manner similar to the left side member 5 by the control path 41′ which is formed like the control path 41 of the left side member 5. The fourth path section 59′ however, runs underneath the fourth path section 59 of the left side member 5 so that the control pins 46 and 46′ can move past one another in the inside positions of the two side members 5 and 5′. The control path 41′ of the right side member 5′ is, in the illustrated example, formed farther to the bottom in its entirety and thus, nearer to the rear guide rail 22 than the control path 41. The pivoting mechanism is adapted accordingly in order to enable identical pivoting of the right side member 5′ so that the right side member 5′ is moved and pivoted synchronously to the left side member 5. In its inside position the right side member 5′ is additionally secured by the control pin 46′ which is held in the middle coulisse 48. The reverse motion of the two side members 5 and 5′ is attained by reversing the above described sequence of motions.

In one alternative embodiment, the rear side members of the motor vehicle roof which laterally encompass the rear roof opening, can also be made movable. Then, in contrast to the described embodiment, the guide on the rear transverse roof member can also be longer than the guide on the front transverse roof member.

In another alternative embodiment, instead of the utilizing the universal joint 29 with the universally jointed shaft 39, a flexible, torsionally strong rotary drive shaft can also be used which is held in a tube. The side member may then be attached to the tube at one or more locations.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

1. A motor vehicle roof comprising:
a roof opening located between two side members;
a movable roof cover for at least one of closing and at least partially clearing the roof opening;
wherein the two side members are movably supported to move transversely from an outside position to an inside position when the roof opening is cleared.

2. The motor vehicle roof as claimed in claim 1, wherein each side member includes a guide mechanism that guides the movable roof cover.

3. The motor vehicle roof as claimed in claim 1, wherein a front end of each side member is movably supported on a front transverse roof component, and a back end of each side member is movably supported on a rear transverse roof component.

4. The motor vehicle roof as claimed in claim 3, wherein the distance moved by the front end of each side member from the outside position to the inside position along the front transverse roof component is different than the distance moved by the rear end of each side member from the outside position to the inside position along the rear transverse roof component.

5. The motor vehicle roof as claimed in claim 3, wherein each side member is movably supported by a front bearing and guide unit on a front guide of the front transverse roof component, and a rear bearing and guide unit on a rear guide of the rear transverse roof component.

6. The motor vehicle roof as claimed in claim 5, wherein each side member is supported on the front and rear bearing and guide units in a manner to allow each side member to pivot around a lengthwise axis.

7. The motor vehicle roof as claimed in claim 5, wherein each side member includes a front drive unit that is drive-engaged to the front guide of the front transverse roof component, and a rear drive unit that is drive-engaged to the rear guide of the rear transverse roof component.

8. The motor vehicle roof as claimed in claim 7, wherein the front drive unit and the rear drive unit are driven simultaneously, the front drive unit traversing a different distance than the rear drive unit.

9. The motor vehicle roof as claimed in claim 7, wherein the front drive unit and the rear drive unit are mechanically coupled to one another.

10. The motor vehicle roof as claimed in claim 7, wherein the front drive unit and the rear drive unit each include a rotary drive element that engages at least one of the guides of a corresponding transverse roof component and an engagement path provided on the guides.

11. The motor vehicle roof as claimed in claim 7, wherein the front drive unit and the rear drive unit each include a drive wheel, the drive wheel of the front drive unit and the drive wheel of the rear drive unit being rotationally coupled to one another, and having different diameters.

12. The motor vehicle roof as claimed in claim 11, wherein the drive wheel of the front drive unit and the drive wheel of the rear drive unit are connected to one another by a shaft.

13. The motor vehicle roof as claimed in claim 12, wherein the shaft is a universally jointed shaft.

14. The motor vehicle roof as claimed in claim 11, wherein the drive wheel of the front drive unit and the drive wheel of the rear drive unit are gears, the teeth of the drive wheel of the front drive unit having a different modulus than the teeth of the drive wheel of the rear drive unit.

15. The motor vehicle roof as claimed in claim 1, further comprising pivoting mechanisms that pivot each of the two side members around lengthwise axes to pivoted positions.

16. The motor vehicle roof as claimed in claim 15, wherein each of the two side members includes a control pin that engages a control path that has a plurality of path segments.

17. The motor vehicle roof as claimed in claim 16, further comprising a control coulisse located along at least one of a front guide of the front transverse roof component and a rear guide of the rear transverse roof component, the control coulisse having the control path.

18. The motor vehicle roof as claimed in claim 16, wherein the control path includes at least one path segment that causes the control pin to pivot the corresponding side member.

19. The motor vehicle roof as claimed in claim 18, wherein the plurality of path segments include a first path segment which is tilted downwardly relative to the displacement direction of the corresponding side member thereby causing the corresponding side member to pivot inwardly.

20. The motor vehicle roof as claimed in claim 18, wherein each of the two side members includes a holding part, the motor vehicle roof further including at least one coulisse positioned along the displacement path of each of the side members, the at least one coulisse being sized to accommodate the holding part of each of the two side members.

21. The motor vehicle roof as claimed in claim 20, wherein the holding part is a supporting pin located on a control arm of one of the two side members, and is positioned coaxially with a pivoting axis of the one of the two side members.

22. The motor vehicle roof as claimed in claim 20, wherein the at least one coulisse includes an outer control coulisse positioned at the outside position of the one of the two side members, and an inner control coulisse positioned at the inside position of the one of the two side members.

23. The motor vehicle roof as claimed in claim 1, wherein at least a rear edge of the movable roof cover is raised and moved rearward over the motor vehicle roof when in the movable roof cover is in the open position.
